(19) United States
(12) Patent Application Publication
(10) Pub. No.: US 2026/0276405 A1
(43) Pub. Date: Sep. 17, 2026

(54) SYSTEM AND METHOD FOR CREATING A MAP, AND METHOD FOR TRAINING A LEARNING ALGORITHM TO PERFORM THE METHOD

(71) Applicant: Robert Bosch GmbH, Stuttgart (DE)

(72) Inventors: Jan Rohde, Dettingen Unter Teck (DE); Max Kirstein, Hohenhameln - Ot Bruendeln (DE); Peter Engel, Hessisch Oldendorf (DE); Thomas Wenzel, Hamburg (DE)

(21) Appl. No.: 19/561,129

(22) Filed: Mar. 9, 2026

(30) Foreign Application Priority Data
Mar. 13, 2025 (DE) 10 2025 109 564.7

(51) Int. Cl. G01C 21/00

(52) U.S. Cl. CPC G01C 21/3841; G01C 21/3815

(57) ABSTRACT

A system for creating a map has a data request device, a mapping module, a map quality monitor, and a data requirement estimator with a learning algorithm. The data request device sends a data request to a fleet vehicle, including a request to send fleet data recorded within a region to the mapping module for mapping. The mapping module maps at least one segment within the region based on the fleet data. The map quality monitor is configured to generate training data based on the map segment for the learning algorithm. The training data includes the map segment and a number of trips required for mapping. The learning algorithm can be trained to predict for the map segment the number of trips required for mapping and to send the predicted number of trips to the data request device.

### CROSS REFERENCE

The present application claims the benefit under 35 U.S.C. § 119 of Germany Patent Application No. DE 10 2025 109 564.7 filed Mar. 13, 2025, which is expressly incorporated herein by reference in its entirety.

### FIELD

The present disclosure relates to a system and a method for creating a map, as well as a method for training a machine learning algorithm to perform the method.

### BACKGROUND INFORMATION

The detection of a vehicle's environment using a perception system, e.g., with a radar sensor and a camera, is a fundamental component of systems for the automated control of vehicles. In this context, environmental data are often supplemented by additional map information, such as information about road layouts. The map data used for this are provided to the vehicle system via a map service.

Conventionally, to create maps, the environmental data of a fleet of vehicles is used and processed into map products. This can also be referred to as crowd sourcing fleet data. The amount of fleet data that is required to achieve a given quality level of a map product has a direct impact on the cost-effectiveness of a map service. In current methods for creating maps, fleet data are typically requested for selected regions.

### BACKGROUND INFORMATION

An object of the present disclosure is to provide an improved system for creating a map and to specify an improved method for creating a map. Furthermore, an object is to specify a method for training a learning algorithm to carry out the method. These objects may be achieved by a system and a method for creating a map and by a method for training a learning algorithm to carry out the method with certain features of the present disclosure. Advantageous developments are disclosed herein.

According to an example embodiment, a system for creating a map includes a data request device, a mapping module, a map quality monitor, and a data requirement estimator with a machine learning algorithm. The data request device is designed to send a data request to at least one fleet vehicle. The data request includes a request to send fleet data recorded within a region to be mapped from at least one fleet vehicle to the mapping module for mapping. The fleet data include sensor data recorded by at least one environmental sensor of at least one fleet vehicle within the region to be mapped. The mapping module is designed to map at least one segment within the region to be mapped based on fleet data and to send at least one map segment mapping the segment to the map quality monitor and/or to the data requirement estimator. The map quality monitor is designed to generate training data based on the map segment for the learning algorithm and to send the training data to the data requirement estimator. The training data include the at least one map segment and a number of trips through the at least one segment by the at least one fleet vehicle required to map the segment. The learning algorithm of the data requirement estimator can be trained based on the training data to predict, for the at least one map segment and/or at least one further map segment that maps a further segment within a further region to be mapped, a number of trips through the segment and/or the further segment by the at least one fleet vehicle that is necessary for mapping, and to send the predicted number of trips to the data request device. The data request device is designed to send an adapted data request based on the predicted number of trips to the at least one fleet vehicle. The adapted data request includes a request to send further fleet data of the at least one fleet vehicle recorded within the at least one segment and/or the at least one further segment to the mapping module for mapping, if the learning algorithm trained based on the training data predicts that the at least one segment and/or the at least one further segment must be traversed by the at least one further fleet vehicle for mapping.

The system is designed to exchange data with the at least one fleet vehicle of a fleet of vehicles. However, the fleet can also include any number of vehicles. At least some of the vehicles of the fleet can be designed as automated vehicles, but this is not absolutely necessary.

The data request device is designed to send the data request to at least one fleet vehicle, while the fleet vehicle is designed to send the fleet data to the mapping module of the system. The fleet data include sensor data from at least one environmental sensor of at least one fleet vehicle.

The environmental sensor can be designed, for example, as a camera, a radar or a lidar device (light detection and ranging, lidar for short). However, the environmental sensor can be designed, for example, as a microelectromechanical sensor, such as an ultrasonic sensor. In principle, the at least one environmental sensor of the at least one fleet vehicle is not limited to a specific modality.

According to an example embodiment, the system can have a mapping manager that is designed to select the region to be mapped and to send information about the region to be mapped to the data request module. The information about the region to be mapped includes coordinates and dimensions of the region to be mapped. In this case, the data request device is designed to create the data request based on the region to be mapped selected by the mapping manager. The mapping manager can also be removed. In any case, the data request must include information about the region to be mapped, i.e., a geographical region, which must be provided to the data request module and to this end can initially be stored in a database. For example, the data request can include a request for fleet data recorded within a city to be mapped from the at least one fleet vehicle and preferably for all fleet data recorded in the city from all fleet vehicles. The data request can also be referred to as a job request.

The mapping module is designed to map the at least one segment within the region to be mapped based on fleet data, i.e., to process the information contained in the fleet data into a map segment. In general, the mapping module is designed to map the at least one segment based on the information contained in the sensor data of the at least one environmental sensor, i.e., to compile it into a map segment. For example, the map segment in the fleet data can include stored information about a road layout and positions of objects such as positions of traffic signs which have been detected by the at least one environmental sensor.

The map segment can be provided to the map quality monitor and/or the data requirement estimator or sent to them. The map quality monitor is designed to generate the training data for the learning algorithm of the data requirement estimator. The training data include the number of trips through the at least one segment by the at least one fleet vehicle required to map the segment. In one embodiment, the map quality monitor is designed to determine the number of trips required for mapping based on a quality measure. The map quality monitor can be designed to generate the quality measure manually or automatically. The quality measure makes it possible to decide when the segment is sufficiently mapped or when the map segment is sufficiently accurate and to specify the number of trips required for sufficient mapping. The training data form so-called annotations or labels for the trainable learning algorithm. The training data therefore include at least one example of a map segment and a corresponding number of trips that is required for adequate mapping.

The learning algorithm can be trained based on the training data to predict, for the at least one map segment and/or at least one further map segment that maps a further segment within a further region to be mapped, a number of trips through the segment and/or the further segment by the at least one fleet vehicle that is necessary for mapping, and to send the predicted number of trips to the data request device. In general, the trained learning algorithm of the data requirement estimator is therefore designed to predict the number of trips that are required for adequate mapping of segments.

Based on the predicted number of trips, an adapted data request can be sent to the at least one fleet vehicle, which includes a request to send further fleet data recorded within the at least one segment and/or the at least one further segment to the mapping module for mapping, if the learning algorithm trained based on the training data predicts that the at least one segment and/or the at least one further segment must be traversed by the at least one further fleet vehicle for mapping.

The system for creating a map therefore advantageously allows fleet data to be selected for mapping and to only use the fleet data that are required for mapping a segment. With each expansion and each update of a map segment, there can be an optimization of the fleet data and data requests for more efficient data usage. The initially created data set can be supplemented and improved as desired with fleet data, for example by transferring newly determined fleet data into an existing data set. The system therefore forms a so-called fleet job management system, into which the learning algorithm is integrated, which can create targeted data requests and send or transmit them to the vehicle fleet.

Sufficiently mapped segments, or sufficiently accurate map segments, for which the learning algorithm of the data requirement estimator predicts that they no longer need to be traversed, can be used to create the map by merging them. This advantageously allows the system to create a map with a defined minimum quality based on as little fleet data as possible. The system therefore makes a significant contribution to the cost-effectiveness of card services.

With an expansion of the mapping region, a change in the fleet behavior and fleet characteristics, or other influencing factors, the required number of trips and boundary conditions can change significantly and in a short time. For this reason, it is advisable to regularly train and update the data requirement estimator with new training data. The system is therefore advantageously able to react automatically to the aforementioned changes.

In one example embodiment, the map quality monitor is designed to generate initial training data when fleet data are not yet available for the at least one segment, and to generate second training data when fleet data from at least one trip by the at least one fleet vehicle is available for the at least one segment.

In one example embodiment, the data request includes a request for metadata of the fleet data and/or boundary conditions for the metadata. The learning algorithm can be trained, based on the metadata and/or the boundary conditions, to predict the conditions required for mapping. In addition to a geographical region, further metadata and boundary values can be requested for mapping. The data request can include, for example, a request for a time, weather conditions, traffic density and/or information about a vehicle type of the at least one fleet vehicle. This data should be referred to as metadata. The data request can also include a request for other metadata; the metadata mentioned here are merely examples.

In addition to the metadata, the data request can also include a request about boundary conditions, i.e., value ranges for the fleet data metadata, such as a minimum and a maximum speed of the at least one fleet vehicle, a vehicle model, or a time range for recording the fleet data.

In one example embodiment, the training data include the metadata of the fleet data and/or the boundary conditions for the metadata. The number of trips of the map segment determinable by the map quality monitor forms the annotations or labels for the learning algorithm to be trained. The metadata and its boundary conditions can supplement these annotations. Advantageously, the learning algorithm can be trained based on the additional metadata and/or the boundary conditions in such a way that it can predict the number of required trips more precisely. As a result, the trained learning algorithm is able to make a prediction based on local conditions for the information given as a label, e.g., for the number of required trips and weather conditions.

In one example embodiment, the training data includes map data generated based on fleet data from initial journeys of the at least one fleet vehicle and/or at least one satellite image and/or at least one free map of the at least one segment. The free maps can also be referred to as OSM maps (English: open street map, abbreviated OSM). This information can be provided, for example, in the form of an image in which each color channel corresponds to the presence of an object (e.g., road, traffic sign, etc.).

In one example embodiment, the system has a category module for determining a segment category of the map segment. The category module is designed to provide the segment category of the map segment to the data requirement estimator.

In one example embodiment, the at least one map segment has a segment length of 10 m to 100 m. Advantageously, this makes it possible to selectively request fleet data for map segments with a small segment length, whereby very little fleet data needs to be processed during mapping. Furthermore, this enables the categorization of the map segment.

In one example embodiment, the learning algorithm is designed as a support vector regressor or as a deep neural network. The aforementioned annotations or labels can be used both in raw form as regression targets, or divided into dedicated classes (e.g., “5-7 trips” or “3-5 pm”) in the training of a regressor/classifier. Conventional functions such as a sum of squares error or a cross-entropy can be used as the loss. A loss function characterizes deviations of values predicted by the learning algorithm from the annotations or labels. This loss function is minimized during training.

According to the present disclosure, a method for training a learning algorithm is provided. According to an example embodiment, the method comprises the following method steps. A data request is sent to at least one fleet vehicle. The data request includes a request to provide fleet data recorded within a region to be mapped from at least one fleet vehicle for mapping. The fleet data include sensor data recorded by at least one environmental sensor of at least one fleet vehicle within the region to be mapped. At least one segment within the region to be mapped is mapped based on the fleet data, and a map segment mapping the at least one segment is provided. Training data are generated for the learning algorithm based on the map segment. The training data include the at least one map segment and a number of trips through the at least one segment by the at least one fleet vehicle required to map the segment. The learning algorithm can be trained based on the training data to predict, for the at least one map segment and/or at least one further map segment that maps a further segment within a further region to be mapped, a number of trips through the segment and/or the further segment by the at least one fleet vehicle that is necessary for mapping.

According to an example embodiment, a method for creating a map using a trained learning algorithm includes the following method steps. An adapted data request is sent to at least one fleet vehicle based on a number of trips predicted by the learning algorithm. The adapted data request includes a request to send further fleet data of the at least one fleet vehicle recorded within the at least one segment and/or the at least one further segment for mapping, if the learning algorithm trained based on the training data predicts that the at least one segment and/or the at least one further segment must be traversed by the at least one further fleet vehicle for mapping. The at least one segment and/or the at least one further segment is mapped based on the further fleet data. Advantageously, within the context of the method, only the fleet data is requested that is required for mapping the segment and/or the further segment, whereby significantly fewer fleet data has to be processed during mapping.

In the following, the system for creating a map, the method for training a learning algorithm, and the method for creating a map in connection with the figure is explained in further detail.

### BRIEF DESCRIPTION OF THE DRAWING

FIG. 1. shows a system for creating a map according to an exemplary embodiment and illustrates the method for training a learning algorithm and the method for creating a map.

### DETAILED DESCRIPTION OF EXAMPLE EMBODIMENTS

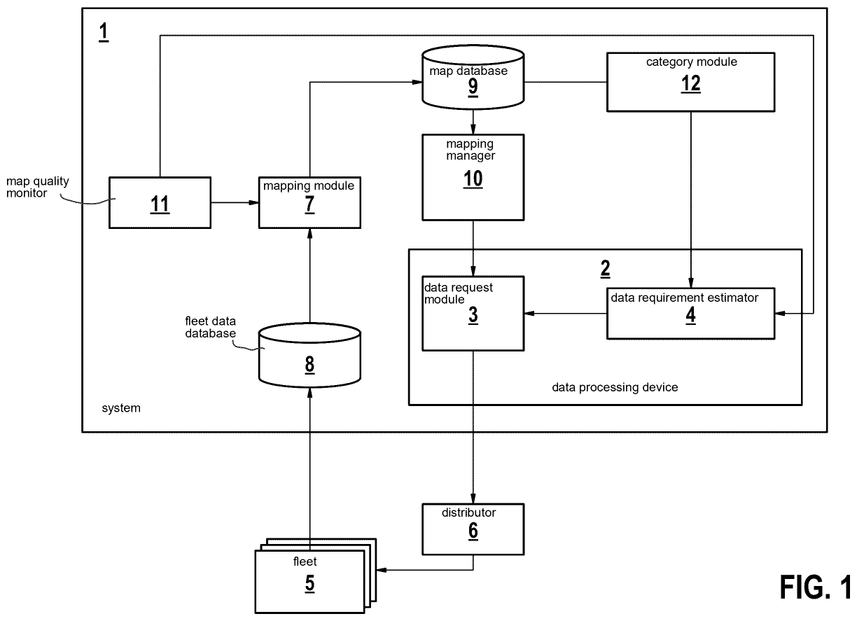

FIG. 1 shows a system 1 for creating a map according to an exemplary embodiment and illustrates the method for training a learning algorithm and the method for creating a map. The system 1 has a data processing device 2. The data processing device 2 has a data request device 3 and a data requirement estimator 4. The data requirement estimator 4 has a learning algorithm that is based on machine learning. The learning algorithm is trainable. The learning algorithm can be designed, for example, as a support vector regressor or as a deep neural network.

The data request device 3 is trained to exchange data with a fleet 5 of vehicles, or to communicate with the fleet 5 of vehicles; in particular however, the data request device 3 is specifically designed to send a data request to the fleet 5. The data request device 3 can send the data request to at least one vehicle in the fleet 5, or at least some of the vehicles in the fleet 5, or to all vehicles in the fleet 5. The fleet 5 can include a plurality of vehicles or at least one vehicle. For example, the system 1 has a distributor 6 which, however, is optional and can also be removed. The distributor 6 is designed to manage data requests and assign them to vehicles of the fleet 5 before they are sent to the fleet 5.

The system 1 further has a mapping module 7. A data request comprises a request to send fleet data recorded within a region to be mapped from a fleet vehicle to the mapping module 7 for mapping. The fleet data include sensor data recorded by at least one environmental sensor of at least one fleet vehicle within the region to be mapped. For example, a fleet vehicle can have a camera and/or a radar sensor and/or a lidar sensor and/or another environmental sensor.

By way of example, the system 1 comprises a fleet data database 8. The fleet data database 8 comprises the fleet data recorded by the fleet 5. The mapping module 7 is designed to request and/or read fleet data from the fleet data database 8 based on the data request. The mapping module 7 is designed to map at least one segment within the region to be mapped based on fleet data and to provide at least one map segment mapping the segment. The mapping module 7 can be designed to send the map segment to a map database 9 of the system 1, or to store the map segment in the map database 9. However, neither the fleet data database 8 nor the map database 9 necessarily have to be part of the system 1. For example, the fleet data database 8 and/or the map database 9 can be designed as external databases.

The map segment provided by mapping module 7 can be used in the context of creating a map comprising a plurality of map segments in that for example the map segments are merged. The map can be created internally within the system 1 or externally, in that for example by map segments from map database 9 are used and merged. FIG. 1 shows by way of example that the system 1 has a mapping manager 10 which is, however, only optional and can also be removed. The mapping manager 10 is designed to select or define the region to be mapped and to send information about the region to be mapped to the data request module 3. The data request module 3 is designed to create data requests based on the region to be mapped. The mapping manager 10 can optionally be designed to create the map based on map segments, wherein the map segments can be requested by the mapping manager 10 from the map database 9, for example, or received directly from the mapping module 7. The mapping manager 10 can be part of the system 1 as shown in FIG. 1, but it can also be designed as an external mapping manager.

The system 1 further has a map quality monitor 11. The mapping module 7 is designed to send map segments to the map quality monitor 11 and/or to the data requirement estimator 4. The map quality monitor 11 is trained to generate training data based on map segments for the learning algorithm and to send the training data to the data requirement estimator 4. The training data include at least one map segment and a number of trips through the at least one segment by at least one fleet vehicle required to map the segment. The map quality monitor 11 can, for example, be designed to determine the number of trips required for mapping based on a quality measure.

The training data can be sent directly from the map quality monitor 11 to the data requirement estimator 4. For example, the system 1 in FIG. 1 has a category module 12. In this case, the map quality monitor 11 is designed to send the training data to the category module 12. The category module 12 is designed to identify or determine a segment category of the map segment. The category module 12 is designed to send the map segment with the information about the segment category to the data requirement estimator at 4. For example, the at least one map segment can have a segment length of 10 m to 100 m along at least one direction of extension in order to allow categorization of the map segment.

The learning algorithm of the data requirement estimator 4 can be trained based on the training data to predict, for the at least one map segment and/or at least one further map segment that maps a further segment within a further region to be mapped, a number of trips through the segment and/or the further segment by at least one fleet vehicle that is necessary for mapping, and to send the predicted number of trips to the data request device 3. The learning algorithm is therefore designed to predict the number of trips of the segment and/or the further segment in that it is trained based on exemplary map segments and the associated number of trips required for mapping from the training data, which serve as annotations.

The data request can also include a request for metadata of the fleet data and/or boundary conditions for the metadata. The mapping module 7 can request the metadata and/or boundary conditions, for example, from the fleet data database 8 and send them to the map quality monitor 11. In this case, the training data comprise the metadata of the fleet data and/or the boundary conditions for the metadata. The metadata and/or boundary conditions can also be used as annotations within the context of training the learning algorithm so that the learning algorithm can be trained based on the metadata and/or boundary conditions to predict conditions required for mapping, such as weather conditions and/or temporal conditions.

The training data can also include map data generated from fleet data from initial trips by the at least one fleet vehicle and/or at least one satellite image and/or a free map of the at least one segment. Different training data can be created for the two different scenarios: that fleet data are not yet available for the at least one segment, or that fleet data are available.

When training the learning algorithm, a data request is sent to at least one fleet vehicle in a first step. In a second step, at least one segment within the region to be mapped is mapped based on the fleet data, and a map segment mapping the at least one segment is provided. In a third step, the training data are generated for the learning algorithm based on the map segment. In a fourth step, the learning algorithm is trained based on the training data. The learning algorithm is trained to predict, for the at least one map segment and/or at least one further map segment that maps a further segment within a further region to be mapped, a number of trips through the segment and/or the further segment by the at least one fleet vehicle that is necessary for mapping. Furthermore, the learning algorithm can be trained to make predictions about metadata and/or boundary conditions.

The data request device 3 is trained to send an adapted data request to at least one fleet vehicle based on the number of trips predicted by the learning algorithm. The adapted data request includes a request to send further fleet data of the at least one fleet vehicle recorded within the at least one segment and/or the at least one further segment to the mapping module for mapping, if the learning algorithm trained based on the training data predicts that the at least one segment and/or the at least one further segment must be traversed by the at least one further fleet vehicle for mapping.

The prediction of the number of trips required for mapping and the adapted the data request ensures that only the fleet data that is necessary for complete mapping is requested. When mapping is considered complete can be established for example, based on the quality measure. In this way, still unmapped segments can be mapped particularly efficiently, or segments that are already at least partially mapped can be updated efficiently. The creation of the map by the system 1 therefore makes it possible to request only the relevant fleet data for mapping from a large amount of fleet data. This makes the system 1 particularly efficient and economical.

When creating a map, the adapted data request can be created for at least one fleet vehicle based on at least one number of trips predicted by the learning algorithm. The adapted data request includes a request to send further fleet data of the at least one fleet vehicle recorded within the at least one segment and/or the at least one further segment for mapping, if the learning algorithm trained based on the training data predicts that the at least one segment and/or the at least one further segment must be traversed by the at least one further fleet vehicle for mapping. In this case, the at least one segment and/or the at least one further segment is mapped based on the additional fleet data, wherein the mapping can also include an update.

What is claimed:

1. A system for creating a map, the system comprising:
a data request device;
a mapping module;
a map quality monitor; and
a data requirement estimator including a machine learning algorithm;
wherein the data request device is configured to send a data request to at least one fleet vehicle, the data request including a request to send fleet data recorded within a region to be mapped from the at least one fleet vehicle to the mapping module for mapping, the fleet data including sensor data recorded by at least one environmental sensor of the at least one fleet vehicle within the region to be mapped;
wherein the mapping module is configured to map at least one segment within the region to be mapped based on the fleet data and to send at least one map segment mapping the at least one segment to at least one of: (i) the map quality monitor or (ii) the data requirement estimator,
wherein the map quality monitor is configured to generate training data based on the at least one map segment for the learning algorithm and to send the training data to the data requirement estimator, the training data including the at least one map segment and a number of trips through the at least one segment by the at least one fleet vehicle required to map the segment,
wherein the learning algorithm of the data requirement estimator can be trained based on the training data to predict, for the at least one map segment and/or at least one further map segment that maps a further segment within a further region to be mapped, a number of trips through the at least one segment and/or the further segment by the at least one fleet vehicle that is necessary for mapping, and to send the predicted number of trips to the data request device;
wherein the data request device is configured to send an adapted data request based on the predicted number of trips to the at least one fleet vehicle, the adapted data request including a request to send further fleet data of the at least one fleet vehicle recorded within the at least one segment and/or the further segment to the mapping module for mapping, when the learning algorithm trained based on the training data predicts that the at least one segment and/or the at least one further segment must be traversed by the at least one fleet vehicle for mapping.

2. The system according to claim 1, wherein the map quality monitor is configured to determine the number of trips required for mapping based on a quality measure.

3. The system according to claim 1, wherein:
the map quality monitor is configured to generate initial training data when fleet data are not yet available for the at least one segment, and
the map quality monitor is configured to generate second training data when fleet data from at least one trip by the at least one fleet vehicle are available for the at least one segment.

4. The system according to claim 1, wherein the data request includes a request for metadata of the fleet data and/or boundary conditions for the metadata.

5. The system according to claim 4, wherein:
the training data include the metadata of the fleet data and/or the boundary conditions for the metadata, and
the learning algorithm can be trained, based on the metadata and/or the boundary conditions, to predict conditions required for mapping.

6. The system according to claim 1, wherein the training data include map data generated based on fleet data from at least one of: (i) initial trips by the at least one fleet vehicle, (ii) at least one satellite image, or (iii) a free map of the at least one segment.

7. The system according to claim 1, wherein the at least one map segment has a segment length of 10 m to 100 m.

8. The system according to claim 1, further comprising:
a category module configured to determine a segment category of the at least one map segment, wherein the category module is configured to provide the segment category of the at least one map segment to the data requirement estimator.

9. The system according to claim 1, wherein the learning algorithm is a support vector regressor or a deep neural network.

10. A method for training a learning algorithm comprising the following steps:
sending a data request to at least one fleet vehicle, wherein the data request includes a request to provide fleet data recorded within a region to be mapped from the at least one fleet vehicle for mapping, the fleet data including sensor data recorded by at least one environmental sensor of the at least one fleet vehicle within the region to be mapped;
mapping at least one segment within the region to be mapped based on fleet data and providing a map segment that maps the at least one segment;
generating training data based on the map segment for the learning algorithm, wherein the training data include the map segment and a number of trips through the map segment by the at least one fleet vehicle required to map the map segment; and
training the learning algorithm based on the training data, wherein the learning algorithm is trained to predict, for the map segment and/or at least one further map segment that maps a further segment within a further region to be mapped, a number of trips through the at least one segment and/or the at least one further segment by the at least one fleet vehicle that is necessary for mapping.

11. A method for creating a map using a trained learning algorithm, the learning algorithm being trained by the following steps including:
sending a data request to at least one fleet vehicle, wherein the data request includes a request to provide fleet data recorded within a region to be mapped from the at least one fleet vehicle for mapping, the fleet data including sensor data recorded by at least one environmental sensor of the at least one fleet vehicle within the region to be mapped,
mapping at least one segment within the region to be mapped based on fleet data and providing a map segment that maps the at least one segment,
generating training data based on the map segment for the learning algorithm, wherein the training data include the map segment and a number of trips through the map segment by the at least one fleet vehicle required to map the map segment, and
training the learning algorithm based on the training data, wherein the learning algorithm is trained to predict, for the map segment and/or at least one further map segment that maps a further segment within a further region to be mapped, a number of trips through the at least one segment and/or the at least one further segment by the at least one fleet vehicle that is necessary for mapping,
the method comprising the following steps:
sending an adapted data request to the at least one fleet vehicle based on a number of trips predicted by the learning algorithm, wherein the adapted data request includes a request to send further fleet data of the at least one fleet vehicle recorded within the at least one segment and/or the at least one further segment for mapping, when the learning algorithm trained based on the training data predicts that the at least one segment and/or the at least one further segment must be traversed by the at least one fleet vehicle for mapping,
mapping the at least one segment and/or the at least one further segment based on the additional fleet data.
